(19) United States
(12) Patent Application Publication
(10) Pub. No.: US 2025/0102381 A1
(43) Pub. Date: Mar. 27, 2025

(54) Measuring device and method for producing and using the same

(71) Applicant: Fraunhofer-Gesellschaft zur Förderung der angewandten Forschung e.V., Munich (DE)

(72) Inventors: Wolfgang Schade, Goslar (DE); Martin Angelmahr, Goslar (DE); Jannis Koch, Goslar (DE)

(73) Assignee: Fraunhofer-Gesellschaft zur Förderung der angewandten Forschung e.V., Munich (DE)

(21) Appl. No.: 18/886,667

(22) Filed: Sep. 16, 2024

(30) Foreign Application Priority Data
Sep. 22, 2023 (DE) 10 2023 209 311.1

(51) Int. Cl. G01L 1/24; G01B 11/16

(52) U.S. Cl. CPC G01L 1/246; G01B 11/165

(57) ABSTRACT

A measuring device is provided having at least one substrate, which contains or consists of a polymer or a glass, at least one optical waveguide being written in the substrate, in which at least one Bragg grating with a predeterminable grating constant is arranged, wherein the measuring device further includes an evaluation device, which is configured to determine a deformation of the substrate and/or a force acting on the substrate from a change in the grating constant and/or a change in the refractive index of the Bragg grating.

### CROSS-REFERENCE TO RELATED APPLICATIONS

This application claims priority under 35 USC § 119 to German Patent Application No. 10 2023 209 311.1, filed Sep. 22, 2023, which is hereby incorporated herein by reference.

### BACKGROUND OF THE INVENTION

The invention relates to a measuring device having at least one substrate which comprises or consists of a polymer or a glass, at least one optical waveguide being written in the substrate, in which at least one Bragg grating with a predeterminable grating constant is arranged. The invention also relates to methods for producing and using measuring devices of this type.

US 2004/0074307 A1 discloses a measuring device having an optical fiber with a fiber Bragg grating. The optical fiber is embedded in a substrate made from a plurality of material layers, wherein these layers comprise a polymer. If a force acts perpendicular to the layers and the optical fiber, the fiber Bragg grating is deformed. This deformation causes a change in the grating constant of the fiber Bragg grating, as a result of which the reflected and transmitted spectra are changed. This change can be optically detected so that the acting force can be determined therefrom.

This known measuring device has the disadvantage that, on the one hand, the optical fiber and, on the other hand, the surrounding polymer layers do not have the same mechanical properties, in particular do not have the same modulus of elasticity. When a force is applied, the polymer layers therefore experience a compression that is different from that of the optical fiber. This leads to a non-linear behavior of the change in the grating constant of the fiber Bragg grating on the basis of the applied force. Furthermore, a precise determination of the force is only possible if it acts exactly over the fiber Bragg grating. If the point of action is shifted within the surface of the measuring device, the force can no longer be reliably determined.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the devices, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 illustrates an exemplary embodiment of a measuring device in longitudinal section;

FIG. 2 illustrates the measuring device according to FIG. 1 in a first cross-section;

FIG. 3 illustrates the measuring device according to FIG. 1 in a second cross-section;

FIG. 4 illustrates the measuring device according to FIG. 1 in a first isometric representation;

FIG. 5 illustrates the measuring device according to FIG. 1 in a second isometric representation;

FIG. 6 illustrates the exemplary use of the measuring device; and

FIG. 7 illustrates, by way of example, the evaluation of the measured values obtained by means of the measuring device.

### DETAILED DESCRIPTION

As required, detailed embodiments of the devices, products, apparatuses, and methods are disclosed herein; however, it is to be understood that the disclosed embodiments are merely exemplary of the devices, products, apparatuses, and methods which can be embodied in various forms. Therefore, specific structural and functional details disclosed herein are not to be interpreted as limiting, but merely as a basis for the claims and as a representative basis for teaching one skilled in the art to variously employ the devices, products, apparatuses, and methods in virtually any appropriately detailed structure. Further, the terms and phrases used herein are not intended to be limiting; but rather, to provide an understandable description of the devices, products, apparatuses, and methods. While the specification concludes with claims defining the features of the devices, products, apparatuses, and methods that are regarded as novel, it is believed that the devices, products, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the devices, products, apparatuses, and methods will not be described in detail or will be omitted so as not to obscure the relevant details of the systems, apparatuses, and methods.

Before the devices, products, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in tum, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

In one aspect a measuring device is disclosed. The measuring device may comprise at least one substrate. The substrate may be a planar element, the thickness of which may be less than the expansion thereof in length and/or width. The substrate may be made of a transparent or translucent material. This means that the substrate is at least partially transparent to at least a portion of the electromagnetic spectrum. In some embodiments of the invention, this partial area of the electromagnetic spectrum may be selected from the infrared and/or visible spectral range.

In some embodiments of the invention, the substrate may have a length and/or a width from about 1 cm to about 50 cm. In some embodiments of the invention, the substrate may have a length and/or a width from about 2 cm to about 20 cm. In some embodiments of the invention, the substrate may have a length and/or a width from about 3 cm to about 10 cm In some embodiments of the invention, the substrate may have a length and/or a width from about 4 cm to about 6 cm. The substrate may have a polygonal or round or oval shape.

In some embodiments of the invention, the substrate may comprise or consist of a polymer. In other embodiments of the invention, the substrate may comprise or consist of a glass. The substrate may have a homogeneous structure. In other embodiments of the invention, the substrate may be composed of a plurality of layers which may consist of identical or different materials. In some embodiments, the layers may differ with regard to their refractive index, which may be influenced, for example, by dopants and/or irradiation.

In some embodiments of the invention, at least one optical waveguide may be integrated into the substrate. This means that the waveguide is located in a partial volume of the substrate so that it is embedded or written in the substrate. The partial volume of the waveguide has a modified refractive index compared to the material of the original substrate so that light which propagates in the waveguide is totally reflected at the interface between the waveguide and the substrate. In this respect, the original substrate represents the cladding of the waveguide and the modified partial volume represents the core of the waveguide. In some embodiments of the invention, the modified refractive index of the core of the waveguide may be greater than the refractive index of the original substrate.

The waveguide or the core thereof further comprises at least one Bragg grating having a predeterminable grating constant. The Bragg grating consists of a plurality of partial volumes or voxels, which are arranged within the core of the waveguide or in the evanescence region next to the core of the waveguide. The individual partial volumes or voxels have a refractive index which is different from that of the core. The spacing between the individual partial volumes or voxels defines the grating constant of the Bragg grating. In some embodiments of the invention, the modified refractive index of the partial volumes or voxels of the Bragg grating may be greater than the refractive index of the waveguide or the core.

The Bragg grating has the effect that a partial spectrum of the light propagating in the waveguide is reflected, said partial spectrum being defined by the grating constant. Light of a different wavelength is transmitted through the Bragg grating. If a force acts on the substrate along the normal vector of the substrate, the Bragg grating in the waveguide is deformed within the substrate. This deformation leads to a change in the grating constant and/or a change in the refractive index of the Bragg grating and may be detected spectroscopically on the basis of the wavelength of the reflected or transmitted light.

For this purpose, the proposed measuring device may further comprise an evaluation unit which is designed to determine a deformation of the substrate and/or the force acting on the substrate from the change in the grating constant. In some embodiments of the invention, the relationship between the change in the grating constant of the Bragg grating and the deformation or the acting force may be linear. This linearity may be caused by the homogeneity of the measuring device. If the substrate, on the one hand, and the waveguide located therein, on the other hand, comprise the same material with the same mechanical properties, the substrate, on the one hand, and the waveguide written or embedded therein with the Bragg grating located therein undergo the same deformation. This may be a difference to known measuring devices in which the waveguide, on the one hand, and the substrate, on the other hand, consist of different materials with different moduli of elasticity. In this case, the deformation under identical force is different, which leads to a non-linear behavior of the measuring device.

In some embodiments of the invention, the Bragg grating may have an elliptical cross-section. In other embodiments of the invention, the waveguide may have an elliptical cross-section. In still another embodiment of the invention, the waveguide and at least one Bragg grating therein may have an elliptical cross-section. The longer axis of the elliptical cross-section can have a fixed angle to the normal vector of the plane defined by the substrate.

In some embodiments of the invention, the measuring device may comprise a plurality of waveguides. In some embodiments of the invention, the number of waveguides may be between about 2 and about 10 or between about 3 and about 7. In some embodiments of the invention, a single waveguide may comprise a plurality of Bragg gratings. In some embodiments of the invention, the number of Bragg gratings may be between about 2 and about 10, or between about 3 and about 7. The individual Bragg gratings within a waveguide may have different grating constants so that they are distinguishable with regard to the wavelength division multiplex. Multiple waveguides and/or multiple Bragg gratings may be used to detect a force distribution within the plane of the measuring device defined by the substrate.

In some embodiments of the invention, the substrate may be planar and, in this way, detect the application of force or the pressure within a planar surface. In other embodiments of the invention, the substrate may be curved in one or more directions and thus detect the application of force to a curved body, such as a cylinder or a sphere or a free-form surface.

In some embodiments of the invention, the substrate may have a thickness of less than 200 μm. In other embodiments of the invention, the substrate may have a thickness of less than about 120 μm. In yet other embodiments of the invention, the substrate may have a thickness of less than about 90 μm. In some embodiments of the invention, the substrate may have a thickness of greater than about 40 μm. In other embodiments of the invention, the substrate may have a thickness of greater than about 50 μm. In yet other embodiments of the invention, the substrate may have a thickness of greater than about 60 μm. On the one hand, substrates of this size may be deformed by forces acting thereon so that the forces may be reliably detected. On the other hand, these substrates render possible a simple integration into existing mechanical components in order to detect the forces acting on these components.

In some embodiments of the invention, the waveguide may have an elliptical cross-section. In other embodiments of the invention, the waveguide may have a circular cross-section. A waveguide of this type may be produced in a simple manner by processing a material by means of a laser, which writes the waveguide into the substrate by point-to-point exposure in that the partial areas irradiated by the laser have a modified refractive index.

In some embodiments of the invention, the Bragg grating may have an elliptical cross-section, the longer axis of symmetrie extending approximately parallel or approximately perpendicularly to the normal vector of the plane defined by the substrate. If the substrate is curved, the axis of symmetry may be parallel or perpendicular to the normal vector at the location of the Bragg grating. This feature has the effect that, when a force is applied in the direction of the normal vector of the plane defined by the substrate, the angles between the longer axis of symmetry of the Bragg grating and the normal vector do not change. When polarized light is used, it is thus possible to detect the relationship between the magnitude of the applied force and the reflection behavior of the Bragg grating with greater accuracy.

In some embodiments of the invention, the waveguide and/or the Bragg grating may be obtainable by processing the substrate with a short-pulse laser. The laser radiation alters the substrate material in the irradiated partial areas in such a way that it has a different refractive index. As a result, the desired waveguides and/or Bragg gratings may be written into the substrate by point-to-point exposure or by the use of a mask.

In some embodiments of the invention, the waveguide and the Bragg grating may be monolithically integrated into the substrate. In the context of the present invention, the term monolithic integration is used when the modulus of elasticity of the waveguide, on the one hand, and the substrate, on the other hand, are essentially identical because the waveguide, on the one hand, and the substrate, on the other hand, consist essentially of the same material which is at most modified with regard to the refractive index by laser material processing or doping. A monolithic integration of this type leads to an identical modulus of elasticity of the components so that an acting force deforms the substrate, on the one hand, and the waveguide, on the other hand, in an identical manner.

In some embodiments of the invention, the measuring device may further comprise a light source by means of which light may be coupled into the waveguide. In some embodiments of the invention, the light source may be a broadband light source, such as a superluminescent diode. In other embodiments of the invention, the light source may be a narrow-band light source, for example a semiconductor laser. The light coupled into the waveguide may propagate therein and be at least partially reflected at the Bragg grating.

In some embodiments of the invention, the measuring device may further comprise a spectrometer by means of which the spectrum reflected at the Bragg grating and/or the spectrum transmitted through the Bragg grating may be determined. In this way, the grating constant of the Bragg grating may be determined from the reflected and/or transmitted light. A change in the grating constant of the Bragg grating due to deformation may be used to determine the acting force or the mechanical stress or the deformation.

In some embodiments of the invention, the substrate may comprise or consist of an aluminosilicate glass. This glass may be processed by short-pulse lasers in a particularly simple manner.

In some embodiments of the invention, the substrate may be curved in one or more directions so that the deformation of a surface curved complementary to the substrate can be determined. In some embodiments of the invention, the substrate may be curved in one or more directions so that the force acting on a surface curved in a complementary manner to the substrate can be determined.

According to another aspect of the invention, a method for detecting a deformation and/or an acting force is disclosed. In order to carry out the method, a measuring device is used which comprises at least one substrate. In some embodiments of the invention, the substrate may comprise or consist of a polymer or a glass. At least one waveguide may be written in the substrate. The waveguide is designed and intended to propagate coupled-in light within the waveguide when the method is carried out. For this purpose, the waveguide may have a refractive index that differs from that of the substrate so that light is totally reflected at the interfaces between the waveguide and the substrate.

The waveguide may also comprise at least one Bragg grating with a predeterminable grating constant. The Bragg grating is designed and intended to reflect a part of the electromagnetic spectrum, whereas another part of the electromagnetic spectrum is transmitted, as described in more detail above in connection with the measuring device.

When the method is carried out, the substrate may be subjected to a force which has at least one component that runs parallel to the normal vector of the substrate. This force leads to an elongation and/or compression of the Bragg grating and thus to a change in the grating constant. A deformation of the substrate and/or the magnitude of the force acting on the substrate may thus be determined from the change in the grating constant.

In some embodiments of the method, the spectrum reflected at the Bragg grating may be determined. In other embodiments of the invention, the spectrum transmitted at the Bragg grating may be determined. In yet other embodiments, both the reflected spectrum and the transmitted spectrum may be measured.

In some embodiments of the invention, a uniaxial pressure perpendicular to the path of the waveguide may be measured. In some embodiments of the invention, a pressure or force distribution over the area of the substrate may further be determined by a plurality of waveguides and/or a plurality of Bragg gratings.

In a further aspect, the invention relates to a method for producing a measuring device. For this purpose, a substrate may first be provided, which may, for example, consist of a polymer or a glass. The substrate may have an expansion with regard to width and length that is greater than the thickness. In order to produce the measuring device, the substrate may be irradiated in partial areas with laser radiation which forms a focal point in the substrate material and, in some embodiments of the invention, has a pulse length from about 50 fs to about 500 fs. By simultaneously moving the substrate perpendicular to the beam expansion, a waveguide may be created in the irradiated volume of the substrate by point-to-point exposure. The waveguide or its core essentially has a partial volume of the substrate which has a different refractive index compared to the non-irradiated substrate material. In some embodiments of the invention, the focal point may, for this purpose, be about 20 μm to about 80 μm below the surface of the substrate. In other embodiments of the invention, the focal point may be about 50 μm to about 70 μm below the surface of the substrate.

In some embodiments of the invention, re-irradiation of the already irradiated volume of the substrate in the waveguide or in the core of the waveguide may be used to then produce a plurality of partial volumes or voxels, which have a refractive index that has been further modified, for example increased, compared to the irradiated volume. The plurality of partial volumes or voxels may be arranged at a predeterminable distance from one another. This results in a Bragg grating having a grating constant that is defined by the spacing of the voxels.

In some embodiments of the invention, the laser radiation may have a pulse energy of about 0.8 ∞J to about 1.1 μJ. In other embodiments of the invention, the laser radiation may have a pulse energy from about 0.95 μJ to about 1.1 μJ. In some embodiments of the invention, the repetition rate of the laser radiation may be between about 4 kHz and about 6 kHz. In some embodiments of the invention, the laser radiation may be circularly polarized. In some embodiments of the invention, the laser radiation may have a wavelength from about 700 nm to about 900 nm. In other embodiments of the invention, the laser radiation may have a wavelength from about 750 nm to about 850 nm. In some embodiments of the invention, the laser radiation may be focused between about 60 μm and about 80 μm deep into the substrate during the production of the measuring device. In some embodiments of the invention, the laser radiation may be focused with an objective lens.

Turning now to the drawings, the invention will be explained in more detail without limiting the general concept of the invention.

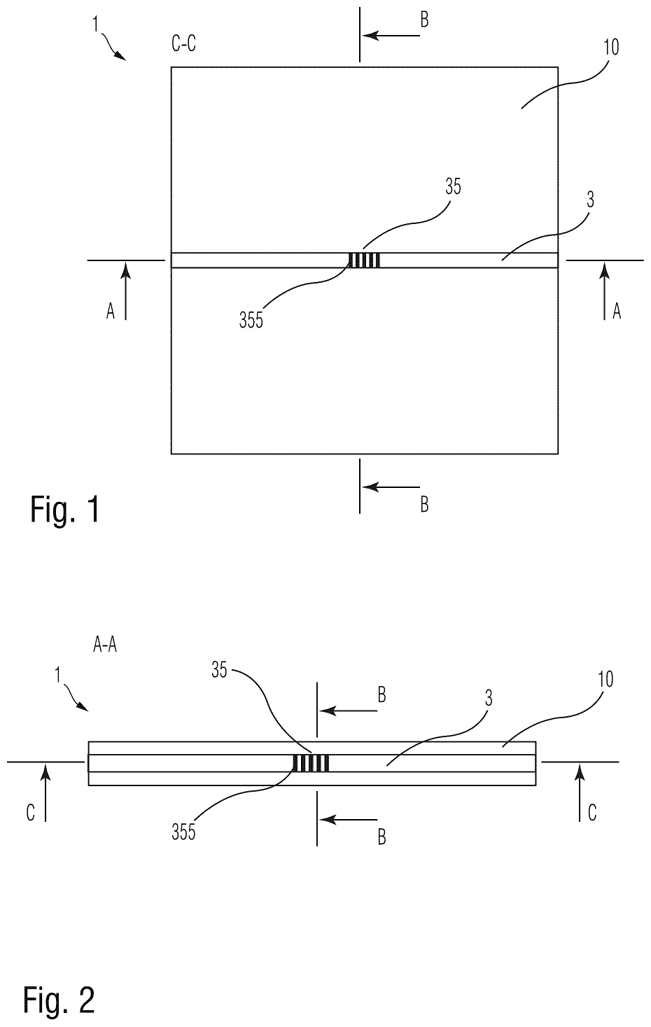

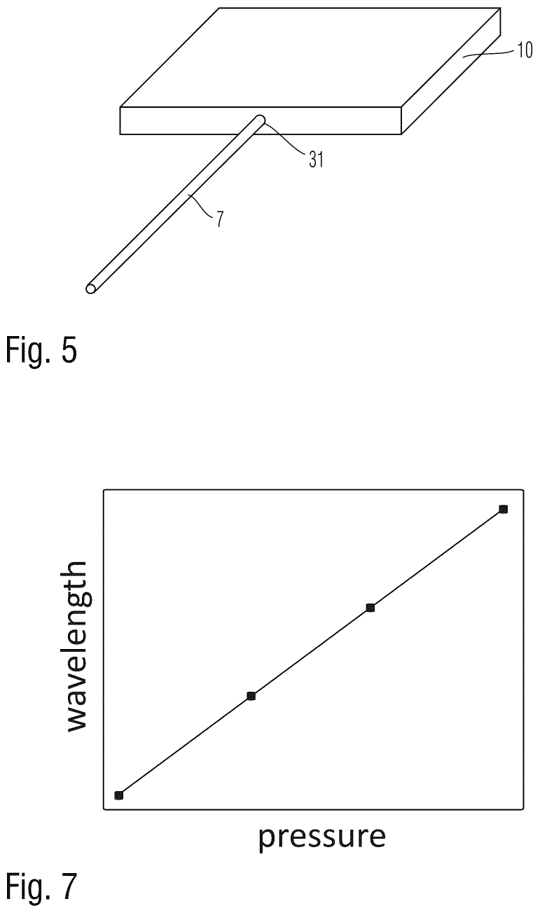

FIGS. 1 to 5 are used to illustrate an exemplary embodiment of a measuring device in more detail. FIGS. 1, 2 and 3 show different sections through the measuring device, FIG. 4 shows a partially sectioned isometric view, and FIG. 5 shows an uncut isometric view. Like features of the invention are always denoted with like reference signs so that not all features of the invention are explained in detail in connection with all the drawings.

The measuring device 1 comprises a substrate 10. The substrate 10 has a top side and a bottom side, which are connected to one another via narrower side surfaces. In the illustrated exemplary embodiment, the substrate 10 is square. The substrate 10 may also have other polygonal, round or elliptical basic shapes. The substrate 10 may have a length and a width of, for example, about 1 cm to about 10 cm in each case. The substrate 10 may have a thickness of, for example, about 40 μm to about 200 μm.

The substrate 10 may be made of a polymer or a glass, for example an aluminosilicate glass. The substrate may comprise a dopant, which may render possible a predeterminable refractive index.

A waveguide 3 is located in the substrate 10. In the illustrated exemplary embodiment, the waveguide 3 runs in a straight line from a first side edge to an opposite second side edge. In other exemplary embodiments, the waveguide may also be curved. In yet other embodiments, a plurality of waveguides 3 may be present in the substrate. The invention does not teach the use of exactly one straight waveguide as a solution principle.

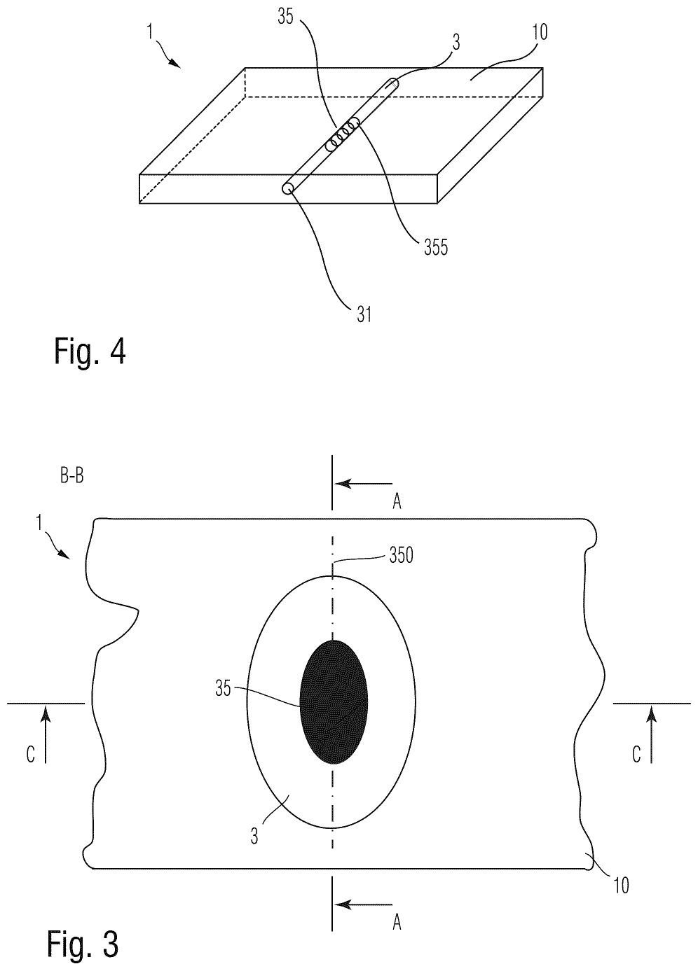

The waveguide 3 is written into the substrate 10 by point-to-point exposure using a short-pulse laser. Laser radiation having a wavelength of 800 nm, a repetition rate of 5 kHz, a pulse duration of 100 fs and a diameter of 6 mm is used for this purpose. The laser radiation is circularly polarized. The pulse energy of a single pulse is 1.01 μJ. The laser radiation is reduced to a diameter of 0.75 mm via an aperture perpendicular to the optical axis of the subsequent waveguide 3. The slit is then focused approximately 70 μm deep into the substrate 10 via an objective lens with a reduction factor of approximately 20 and a numerical aperture of 0.4. The substrate is then moved at a speed of about 2 mm/s perpendicular to the incoming laser beam. This results in an increase in the refractive index of the irradiated substrate 10 in the focal volume. After moving the substrate underneath the objective lens, the irradiated volume has the shape of a cylinder with a diameter of about 6 μm. As shown in FIG. 3, this cylinder has an elliptical cross-section. In other embodiments of the invention, the cross-section may also be round.

By increasing the refractive index in the irradiated volume, a total reflection occurs at the interface of the waveguide 3 so that light may be guided in the waveguide 3 within the substrate 10.

Then, at least one Bragg grating 35 is arranged in the waveguide 3. For this purpose, the pulse energy is increased to 1.06 μJ. The speed at which the substrate is moved under the objective lens is increased so as to adapt the Bragg condition for the 6th order for the desired wavelength range. In this way, a plurality of spatial regions or voxels 355 are written into the waveguide, which have a further increased refractive index compared to the waveguide 3. The spacings between the voxels define the grating constant of the Bragg grating.

As may be best seen in FIG. 3, a shorter axis of symmetry of the Bragg grating and/or the waveguide is localized perpendicular to the surface of the substrate, i.e. the longer axis of symmetry 350 of the elliptical cross-section assumes a fixed angle to the normal vector of the plane defined by the substrate 10. In the illustrated embodiment, the angle between the longer axis of symmetrie 350 of the elliptical cross-section and the normal vector is 0°, i.e. the longer axis of symmetrie 350 and the normal vector are parallel.

If a force is applied to the substrate in the direction of the normal vector, the symmetry planes of the Bragg grating or of the waveguide remain perpendicular or parallel to the surface of the substrate repectively. As a result, the relationship between the magnitude of the applied force and the reflection behaviour of the Bragg grating may be detected with greater accuracy when using polarized light.

It should be noted that in other embodiments of the invention, a plurality of Bragg gratings 35 may also be present in a waveguide 3 or also in a plurality of waveguides 3. A plurality of Bragg gratings 35 may have different grating constants so that the spatial position within the substrate 10 may be detected in the wavelength division multiplex.

As shown in FIG. 4, the waveguide 3 terminates in an opening 31 on a side surface of the substrate 10. A optical fiber 7 may be contacted to the waveguide 3 using a UV-curing, transparent adhesive. In some embodiments of the invention, the optical fiber 7 may be a single mode optical fiber. In particular if a plurality of Bragg gratings 35 are arranged in the waveguide 3, the optical fiber 7 may also be a multi-mode optical fiber.

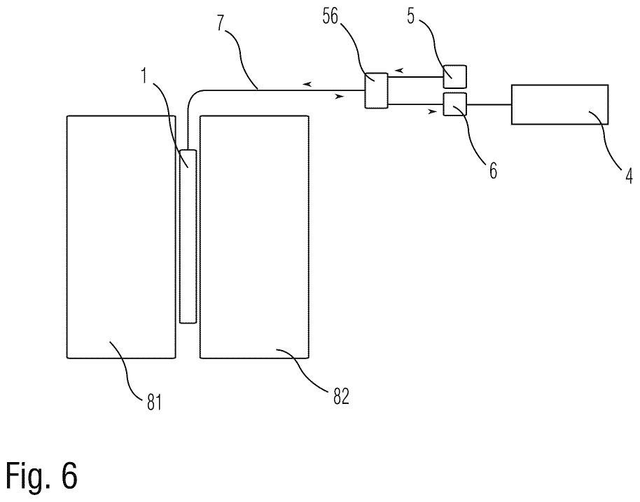

FIG. 6 is used to illustrate the detection of a deformation or an acting force by means of the measuring device 1 in more detail. In the illustrated exemplary embodiment, the measuring device 1 is arranged between two battery cells 81 and 82. The two battery cells 81 and 82 may be prismatic cells or also round cells. In this case, the measuring device 1 is only in linear contact with the two cylindrical housings of the battery cells 81 and 82. During a charging or discharging cycle and/or due to ageing, the housings of the battery cells 81 and 82 expand. This exerts a force on the measuring device 1, which leads to a deformation of the measuring device 1. As a result, this deformation changes the grid constant of the Bragg grid 35, and this change may be detected with the below described device. Therefore, the measuring device 1 is used, by way of example, to monitor the state of charge or the ageing of the battery cells 81 and 82.

In other embodiments of the invention, the measuring device 1 may also be arranged between other mechanical components, for example parts of a machine tool or a vehicle or aircraft, instead of between the battery cells 81 and 82.

The optical fiber 7 is connected to a light source 5 and a spectrometer 6 by means of an optical coupler or circulator 56. The light source 5 may be e.g. a semiconductor laser or a superluminescent diode, which emits light via the coupler or circulator 56 into the optical fiber 7 and from there into the waveguide 3 in the substrate 10 of the measuring device 1. The partial spectrum reflected at the Bragg grating 35 is reflected in the waveguide 3 and again reaches the spectrometer 6 via the optical fiber 7 and the coupler or circulator 56. The wavelength of the reflected light is detected in the spectrometer 6 and is supplied to an evaluation device 4, which uses the reflected wavelength to detect the deformation of the substrate or the force acting on the substrate 10.

FIG. 7 shows the pressure or the force acting on the substrate 10 on the abscissa and the wavelength of the reflected light on the ordinate. As may be seen from FIG. 7, there is a linear relationship between wavelength and force or pressure. This linear relationship is due to the fact that the waveguide 3 and the substrate 10 are made of the essentially identical material and therefore have the same modulus of elasticity. Due to the monolithic integration of the waveguide 3 and the Bragg grating 35 in the substrate 10, the mechanical stress may propagate homogeneously in the substrate 10 and thus render possible a simple and reliable detection of the force or deformation.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature may not be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments may be made by those skilled in the art without departing from the scope of the systems, apparatuses, and methods as defined by the following claims.

1. A measuring device comprising:
at least one substrate, which comprises a polymer or a glass, wherein at least one optical waveguide is written into the substrate, in which at least one Bragg grating having a grating constant is arranged; and
an evaluation device configured to determine a deformation of the substrate and/or a force acting on the substrate from a change in the grating constant and/or a change in the refractive index of the Bragg grating, wherein the Bragg grating or the waveguide or both have an elliptical cross-section, and a longer axis of symmetry of the elliptical cross-section is arranged at a fixed angle to the normal vector of the plane defined by the substrate.

2. The measuring device of claim 1, wherein the substrate has a thickness of less than 200 μm or less than 120 μm or less than 90 μm.

3. The measuring device of claim 1, wherein the substrate has a thickness of more than 40 μm.

4. The measuring device of claim 1, wherein the longer axis of symmetry is parallel or perpendicular to the normal vector of the plane defined by the substrate.

5. The measuring device of claim 1, wherein the modulus of elasticity of the waveguide and the substrate is essentially identical.

6. The measuring device of claim 1, wherein the waveguide and the Bragg grating are monolithically integrated in the substrate.

7. The measuring device of claim 1, further comprising: a light source configured to couple light into the waveguide; and a spectrometer, configured to determine the spectrum reflected at the Bragg grating and/or the spectrum transmitted through the Bragg grating.

8. The measuring device of claim 1, wherein the substrate comprises a glass.

9. The measuring device of claim 8, wherein the substrate comprises an aluminosilicate glass.

10. A method for detecting a deformation and/or an acting force, the method comprising:
providing at least one substrate, the at least one substrate comprising a polymer or a glass, wherein at least one optical waveguide is integrated in the substrate and wherein at least one Bragg grating having a grating constant is arranged in the waveguide, wherein the Bragg grating or the waveguide or both have an elliptical cross-section, and a longer axis of symmetry of the elliptical cross-section is arranged at a fixed angle to the normal vector of the plane defined by the substrate;
applying a force to the substrate; and
detecting a deformation of the substrate and/or a magnitude of the force acting on the substrate from a change of the grating constant of the at least one Bragg grating.

11. The method of claim 10, wherein the change of the grating constant of the at least one Bragg grating is detected by measuring the spectrum reflected at the Bragg grating or the spectrum transmitted through the Bragg grating.

12. The method of claim 10, wherein the substrate is curved in at least one direction and the deformation of a surface curved in a complementary manner to the substrate is determined.

13. The method of claim 10, wherein the substrate is curved in at least one direction and the force acting on a surface curved in a complementary manner to the substrate is determined.

14. The method of claim 10, wherein a uniaxial pressure is measured perpendicular to the length of the waveguide.

15. A method for producing a measuring device having at least one substrate which comprises a polymer or a glass, wherein at least one optical waveguide is written into the substrate, in which at least one Bragg grating having a grating constant is arranged, wherein the Bragg grating or the waveguide or both have an elliptical cross-section, and a longer axis of symmetrie of the elliptical cross-section is arranged at a fixed angle to the normal vector of the plane defined by the substrate,
said method comprising:
providing a substrate having a first refractive index, irradiating the substrate with laser radiation forming a focal point in the substrate and having a pulse length from about 50 fs to about 500 fs;
moving the substrate perpendicular to the laser beam to carry out a first irradiation, said first irradiation creating a waveguide core in the irradiated volume of the substrate, said waveguide core having an increased refractive index compared to the first refractive index;
re-irradiating a part of the waveguide core with said laser radiation so that a plurality of partial volumes are formed in the waveguide, which have an increased refractive index compared to the waveguide core and which form a Bragg-grating.

16. The method of claim 15, wherein the laser radiation has a pulse energy of about 0.8 μJ to about 1.1 μJ.

17. The method of claim 15, wherein a repetition rate of the laser radiation is selected from about 4 kHz to about 6 KHz.

18. The method of claim 15, wherein the laser radiation is circularly polarized.

19. The method of claim 15, wherein the wavelength of the laser radiation is selected from about 700 nm to about 900 nm.
